(19) United States
(12) Patent Application Publication
(10) Pub. No.: US 2019/0303716 A1
(43) Pub. Date: Oct. 3, 2019

(54) IDENTIFICATION OF INPUT FEATURES USED BY MACHINE LEARNING MODEL IN PROVIDING OUTPUT SCORE

(71) Applicant: ENTIT Software LLC, Sunnyvale, CA (US)

(72) Inventors: Manish Marwah, Palo Alto, CA (US); Xiao Zhang, Sunnyvale, CA (US); Martin Arlitt, Calgary (CA)

(21) Appl. No.: 15/938,624

(22) Filed: Mar. 28, 2018

(51) Int. Cl. G06K 9/62; G06F 17/18; G06F 17/17; G06F 15/18

(52) U.S. Cl. CPC G06K 9/6247; G06F 15/18; G06F 17/175; G06F 17/18

(57) ABSTRACT

Points around a point of interest are sampled. The points and the point of interest each have a value for each of a number of input features. The points and the point of interest each have a corresponding output score for a machine learning model. A feature contribution vector for the input features is determined by locally approximating the machine learning model at the points and the point of interest using a model, such as a ridge regression model. The ridge regression model can have a loss function, which can include a Kullback-Leibler (KL) divergence term. The feature contribution vector approximates for any point a contribution of each input feature to the output score of this point by the machine learning model. The input features most responsible for the machine learning model having provided the corresponding output score for the point of interest, based on the feature contribution vector, are provided.

### BACKGROUND

Artificial intelligence, or machine intelligence, is a technology by which machines like computing devices exhibit intelligence or cognitive functions typically associated with the human mind. One type of artificial intelligence is machine learning. Machine learning is a technology that permits computing systems the ability to “learn” (i.e., progressively improve in performance) as increased amounts of data are provided to the underlying machine learning model, without having to be explicitly programmed. Over time, as a machine learning model has been exposed to large amounts of input and output data, the model can provide accurate prediction of output data for given input data. Machine learning can be considered as particular to the capabilities of a computing device, insofar as the underlying models are intractable for human users to perform. Indeed, the manner or mechanism by which a machine learning model generates output data for provided input data—i.e., “why” the model generated the output it did for provided input data—can be inscrutable even for the human users who programmed the initial model.

### BRIEF DESCRIPTION OF THE DRAWINGS

FIG. 1 is a diagram illustratively depicting an example of identifying input features that a machine learning model primarily used to generate an output score.

FIG. 2 is a flowchart of a method for identifying input features that a machine learning model primarily used to generate an output score.

FIG. 3 is a flowchart of a method for identifying input features that a machine learning model primarily used to generate an output score.

FIG. 4 is a block diagram of a computing device for identifying input features that a machine learning model primarily used to generate an output score.

FIG. 5 is a flowchart of a method for identifying input features that a machine learning model primarily used to generate an output score.

FIG. 6 is a diagram of a storage medium storing instructions that when executed by a processor identify input features that a machine learning model primarily used to generate an output score.

FIG. 7 is a block diagram of a computing device that identifies input features that a machine learning model primarily used to generate an output score.

### DETAILED DESCRIPTION

As noted in the background section, a machine learning model after having been exposed to large amounts of data (i.e., “big data”) can accurately provide output data, which is referred to herein as an output score, for provided input data. A singular provided input data can be referred to as a point, or as a data point, which has values for each of a number of different input features of an input feature vector. The number of input features can be large, having orders of magnitude in the tens, or even hundreds or more.

An example of a point, for instance, within a sequence or time series of data can include features derived from a particular sub-sequent or time window. With respect to images or video, a point may be a specific image or a particular frame of a video. With respect to text, a point may be a word, sentence, or an entire document, for example.

A machine learning model is generally a “black box.” That is, as noted in the background section, why the model generated a particular output score for a provided data point can be inscrutable. Even an understanding of the underlying machine learning model does not assist in identifying specifically which input features of the data point contributed most greatly to the machine learning model providing the output score that it did. As such, end users may be more loathe to trust the output of a machine learning model, even if the model is objectively proven to be highly accurate, since the users do not understand how the model comes up with the output scores that it does.

Techniques described herein improve the ability of a computing system to interact with users, by identifying the input features of a provided data input that a machine learning model primarily used to generate the output score that it did for this data point. In general, a number of data points around a particular data point of interest are sampled, and the machine learning model is locally approximated using a simpler model like a ridge regression model. The result of this local approximation of the machine learning model is an identification of the contribution of each input feature to the output score for the point of interest.

As such, the capability of the computing system in interacting with a user with respect to its machine learning model is improved. Rather than just providing an output score for a data point that has been input to the machine learning model, the computing system can thus identify the input features of the data point that most contributed to the generation of the output score in question. Such improved interaction with the user improves the capabilities of the computing system, insofar as the computing system's capability in performing machine learning is enhanced via identification of the input features that were most responsible for the machine learning model having generated particular output scores for particular input data points.

Furthermore, the identified input features can be varied to control a specified system that resulted in the output score. For example, the output score may be an anomaly score indicative of the extent to which a given computing system is performing optimally. The computing system may have a large number of input features, including data processing throughput, memory throughput, fan speed, temperature, humidity, number of currently run processes, networking throughput, and so on. A machine learning model may be employed to generate an anomaly score indicative of the extent to which the computing system is performing optimally, from these input features.

Then, if the anomaly score is greater than (or less than in another implementation) a specific threshold, the input features that have identified as most responsible for the anomaly score can be adjusted to reduce (or increase) the score so that the system performs more optimally. The input features in this respect can be considered as actuators that can be controlled to ensure that a system operates as intended. Insofar as there can be a large number of actuators, identifying which actuators to automatically control responsive to a machine learning model generating an undesired anomaly score may otherwise prove difficult. To the extent that the input features may not be directly controllable or actuatable (as is the case with environmental features like temperature and humidity), the input features may first be transformed into those that can be directly manipulated, prior to the identification of those that are most responsible for the anomaly score in question.

A computing system is one type of system that can be controlled in this manner. Other types of systems include physical systems, such as a building's environmental controls, as well as an electrical grid system, a manufacturing facility system, and so on. In each type of system, the input features can be actuators that can be controlled, once they have been identified using the techniques described herein.

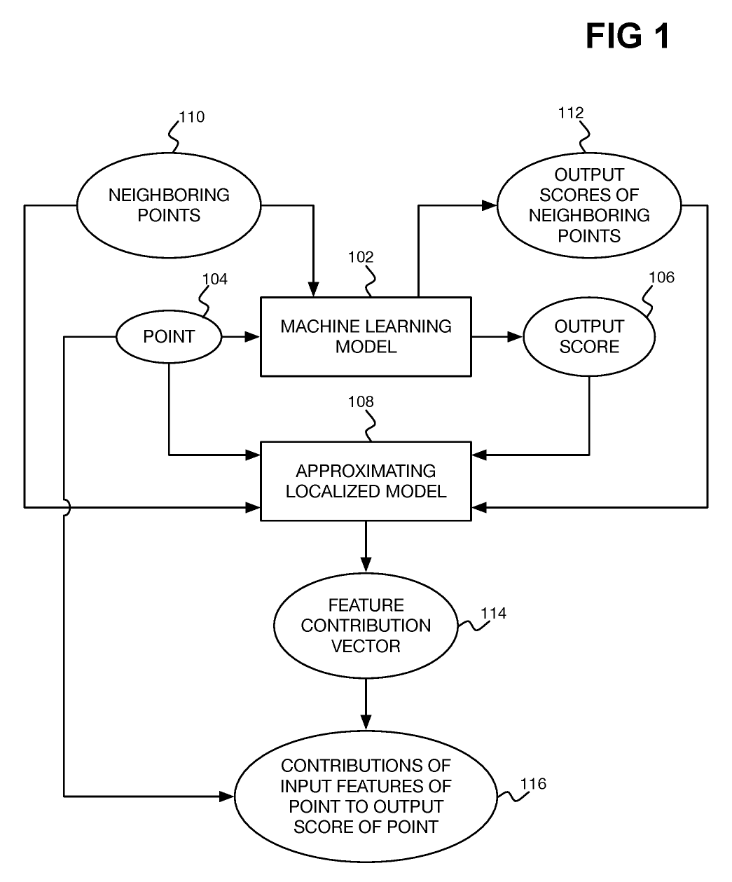

FIG. 1 illustratively depicts an example for identifying input features that a machine learning model primarily used to generate an output score. A machine learning model 102 receives a point of interest 104 as input and correspondingly provides, generates, or outputs an output score 106. The machine learning model 102 can be a deep neural network model, or another type of complex machine learning model, such as a random forest model, a gradient boosting machine, a support vector machine (SVM), and so on. The machine learning model 102 is generally a “black box,” in that the specifics as to how, and why, the model 102 generated the output score 106 for the point of interest 104 cannot be analyzed.

The point of interest 104 itself can have values for a number of different input features of an input feature vector. These different input features can number in the tens, hundreds, or even more. Based on its prior training, the machine learning model 102 generates the output score 106 based on the values of the point of interest 104 for the input features. However, the output score 106 is not a simple function or model of the values of the input features as to the point of interest 104, and this is why the machine learning model 102 can be considered a “black box.” The input feature or features that most contribute to a particular point of interest 104 having a specific output score 106 can vary depending on the values that the point of interest 104 in question has for the input features of the feature vector, for instance.

An approximating localized model 108 receives as input the point of interest 104 (i.e., the values of the point of interest 104 for the input features of the feature vector) and the output score 106 that the machine learning model 102 generated. The approximating localized model 108 also receives as input a number of sampled neighboring points 110 around the point of interest 104 within an M-dimensional space of the M input features of the feature vector. The approximating localized model 108 further receives as input the corresponding output scores 112 that the machine learning model 102 generated for these neighboring points 110.

The approximating localized model 108 is a simplified model, such as a linear regression model with L2 regularization, which is also referred to as a ridge regression model. The model 108 is fitted to the points 104 and 110 and their corresponding output scores 106 and 112, to approximate the output scores 106 and 112 that the machine learning model 102 generated for the respective points 104 and 110, with minimal error, or loss. In this respect, the approximating localized model 108 can have a loss function that is minimized during fitting of the model to the points 104 and 110 and their output scores 106 and 112.

The approximating localized model 108 is a localized model 108 in that it attempts to mimic the machine learning model 102 just with respect to a neighborhood of data points including the point of interest 104 and the neighboring points 110 sampled around the point of interest 104. The approximating localized model 108 is an approximating model in that it may not provide the same output score for a data point within the neighborhood of data points that the machine learning model 102 does. However, because the model 108 is a simplified model, such as a linear regression model, the model 108 is not a “black box,” and which input features contribute to the output score for any data point within the neighborhood of data points can be discerned once the model 108 has been fitted to the points 104 and 110 and their corresponding output scores 106 and 112.

As such, the approximating localized model 108, once fit to the point of interest 104 and its output score 106, and to the neighboring points 110 sampled around the point 104 and their output scores 112, yields a feature contribution vector 114. The feature contribution vector 114 includes a number of feature contribution coefficients corresponding to the input features. The feature contribution vector 114 along with the point of interest 104 itself can then be used to identify the contributions 116 of the input features of the point 104 to its output score 106. More specifically, the contribution 116 of each input feature of the point 104 to its output score 106 can be determined using the feature contribution coefficient corresponding to the input feature in question along with the value of the point 104 for this input feature.

Therefore, the contributions 116 of the input features of the point of interest 104 to the output score 106 that the machine learning model 102 generates for the point 104 can serve as the explanation for why the model 102 provided the output score 106 for the input point 104. That is, which input features most contributed to the machine learning model 102 generating the output score 106 for the point of interest 104 are identified, even though the model 102 is a “black box” and hence in actuality ultimately inscrutable to such exacting analysis. In this way, computing device capability is improved.

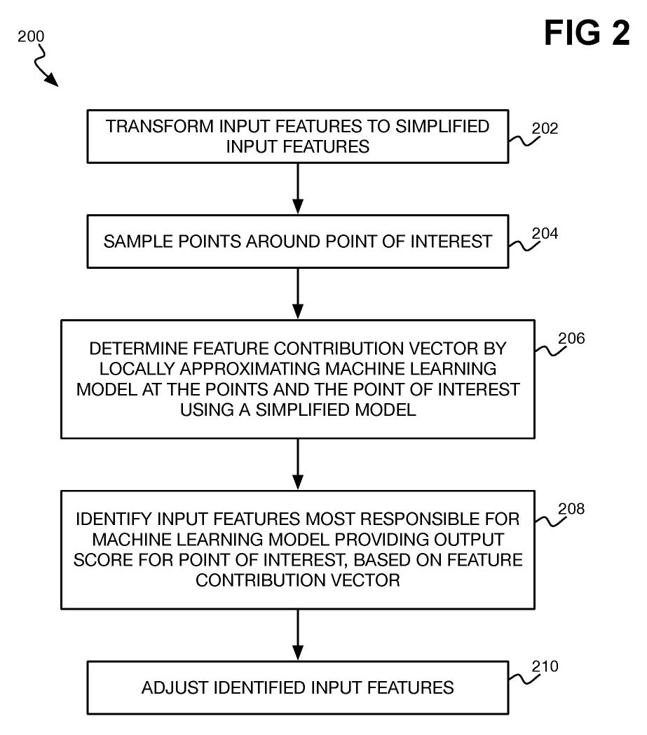

FIG. 2 shows a method 200 for using a simplified, approximating localized model to identify the input features that a complex machine learning model primarily used to generate an output score for a particular point of interest. A computing device can perform the method 200. For instance, the method 200 can be implemented as program code that is stored on a non-transitory computer-readable data storage medium, and which a processor of the computing device executes to perform the method 200.

The point of interest can be considered as a vector x having a value x^{a} for each of M number of features a=1 . . . M. The machine learning model can be represented as f. As such, the machine learning model generates an output score y for the point of interest x; i.e., y=f(x).

In one implementation, the input features may be transformed to a set of simplified input features (202). The point of interest x may be thus be transformed to the point of interest x′ having a value x′^{a′} for each of M′ number of features a′=1 . . . M′, where M′ may be smaller than M. This implementation may be employed when the M number of features are themselves difficult to comprehend, such that providing information that a given feature or features most contributes to the machine learning model having generated the output score y for the point of interest x is not particularly useful. The simplified input features may represent a grouping or clustering of the input features, where each such grouping or clustering is more easily understood than the individual input features themselves.

In an implementation in which the input features primarily responsible for a machine learning model having generated a particular output score are to be identified so that they can be subsequently actuated, the simplified input features in part 202 can be actuatable input features. For instance, not every input feature of a data point may be directly controllable. As an example, ambient environmental measurements, like temperature and humidity, are not directly controllable, but rather may be influenced by other input features that can be, such as fan speed. Therefore, the set of input features of a data point that have been input to a machine learning model may be transformed in part 202 to a set of simplified input features that are directly controllable or actuatable.

The remainder of the description of the method 200 assumes that part 202 is not performed. As such, the remainder of the method 200 is described in relation to the vector x having a value x^{a} for each of M number of features a=1 . . . M. However, this description pertains equally to the vector x′ having a value x′^{a′} for each of M′ number of features a′=1 . . . M′, if part 202 is performed.

Points in an M-dimensional space of the M input features in the neighboring vicinity around the point of interest x are sampled (204). There may be N such points sampled around the vector x, according to a specified distribution, such as a multivariate normal distribution centered at x, with a covariance of 0.01I, where I is an identity matrix. The approximating localized model that is fitted to the machine learning model to explain why the machine learning model provided the output score y for the point of interest x is specifically fitted to the machine learning model within this localized neighborhood of N sampled points around the point of interest x. That is, the approximating localized model approximates the machine learning model for this neighborhood of N sampled points, and not for all points that may have been input to the machine learning model. Like the point of interest x, each of the N sampled points has a value for each input feature, and likewise has a corresponding output score generated by the machine learning model.

A feature contribution vector is determined by locally approximating the machine learning model at the sampled points and at the point of interest X using a simplified model (206), such as the approximating localized model. In one implementation, the model may be a ridge regression model, which is a linear regression model with L2 regularization. The remainder of the detailed description is described in accordance with a ridge regression model, but the model may be a different type of model as well. An example of another type of a model is a lasso model, which is a linear regression model with L1 regularization.

The variation or difference between the ridge regression model and the machine learning model over the point of interest and the sampled points is captured by a loss function. Therefore, fitting the ridge regression model to the point of interest and its output score, and to the sampled points and their output scores, involves minimizing the loss function. The loss function can be constructed such that sampled points nearer to the point of interest are weighted higher than sampled points that are farther away. This can be achieved through a proximity kernel weighing a residual from linear regression.

In one implementation, the loss function can be:

$$loss = \frac{1}{N} {\sum }_{j = 1}^{N} π ( x , {x}_{j} ) \cdot {( {w}^{T} {x}_{j} - y )}^{2} + α {‖ w ‖}_{2}^{2} . \qquad ( 1 )$$

In this loss function, N is the number of sampled points, π(x,xⱼ) is the proximity kernel between the point of interest x and the sampled point xⱼ.

Furthermore, w is a feature contribution coefficient vector, T is the transposition function, and α is a prespecified hyper-parameter related to a regularization term of the ridge regression. The feature contribution coefficient vector has a feature contribution coefficient w^{a} for each of M number of features a=1 . . . M. That is, the feature contribution coefficient vector itself is made up of feature contribution coefficients corresponding to the input features. Each feature contribution coefficient is thus indicative of the contribution of the input feature to which the coefficient corresponds, to the output score of the point in question as provided by the machine learning model. The proximity kernel can in one implementation be defined as:

$$π ( x , {x}_{j} ) = {e}^{\frac{{‖ x - {x}_{j} ‖}_{2}^{2}}{{σ}^{2}}} . \qquad ( 2 )$$

In this proximity kernel, σ is a predefined kernel width.

Minimizing the loss function presented above in fitting the ridge regression model can result in a uniform distribution of feature contributions. If there are a large number of features, however, a different distribution may be desired to bias towards a “skewed” or “spiky” explanation among multiple similar explanations. Therefore, in one implementation, an additional term is added to the loss function presented above, to nudge the solution away from a uniform distribution. Such a term can bias the ridge regression model away from a uniform distribution approximation of the contributions of the input features to the output score provided by the machine learning model.

This additional term can be a Kullback-Leibler (KL) divergence term, and is subtracted from the loss function. The KL divergence term can be specified as:

$$KL ( P \vert \vert Q ) = {\sum }_{i = 1}^{M} P ( i ) \cdot log \frac{P ( i )}{Q ( i )} . \qquad ( 3 )$$

Here, P is the uniform distribution, and Q is the distribution of the feature contributions. The additional term subtracted from the loss function may be the KL divergence term multiplied by a hyper-parameter β, which can be specified to control the extent to which the KL divergence term affects the loss function (i.e., the extent to which fitting of the ridge regression model is biased away from a uniform distribution).

The KL divergence term can be considered a regularization term that nudges the solution towards a smaller number of features, to provide a simpler and more skewed explanation of an output score. The term thus biases the ridge regression model towards a minimization of the number of input features that maximally contribute to the output score provided by the machine learning model, in approximating these contributions to the output score. The hyper-parameter determines the desired degree of skew in the contribution distribution. A high value can result in the selection of one feature, while low values will bias back towards a uniform distribution equally selecting all the input features. It is noted that when the KL divergence term is employed, the loss function remains convex. Besides the KL divergence term, other measures that quantify distance between two distributions can be used, such as the Hellinger distance, or the earth mover's distance (EMD).

The result of part 206 of the method 200 (i.e., including fitting the ridge regression model) can be a feature contribution vector, which is the product of the feature contribution coefficient vector w and a particular point, such as the point of interest x. The feature contribution vector approximates, for any point within the localized neighborhood of N sampled points around the point of interest (and including the point of interest), the contribution of each input feature to the output score of that point as provided by the machine learning model. As such, the input features most responsible for the machine learning model having provided the output score for the point of interest, using the feature contribution vector, can be provided (208), such as by outputting the input features.

In addition to or in lieu of providing the input features identified in part 208, these input features may be subsequently adjusted to affect the output score that the machine learning model generated for a computing system (210). For instance, as noted above, a computing system may have a number of input features that are input into a machine learning model to provide an output score indicative of whether the computing system is performing anomalously. The method 200 may be performed if this anomaly score is greater than a threshold, to identify those input features most responsible for the machine learning model having generated this score. The identified input features can then be adjusted automatically so that the computing system again performs properly, and not anomalously.

As such, self-healing capability of the computing system is enhanced. A complex machine learning model may be employed to assess current performance of the computing system—even a model that is a “black box” for which the input features that the model most used to generate a particular output score cannot be inherently provided. Insofar as such a complex model may be more accurate than simplistic models used to generate output scores, self-healing capability of a computing system is improved, because the techniques described herein permit the usage of such a complex model.

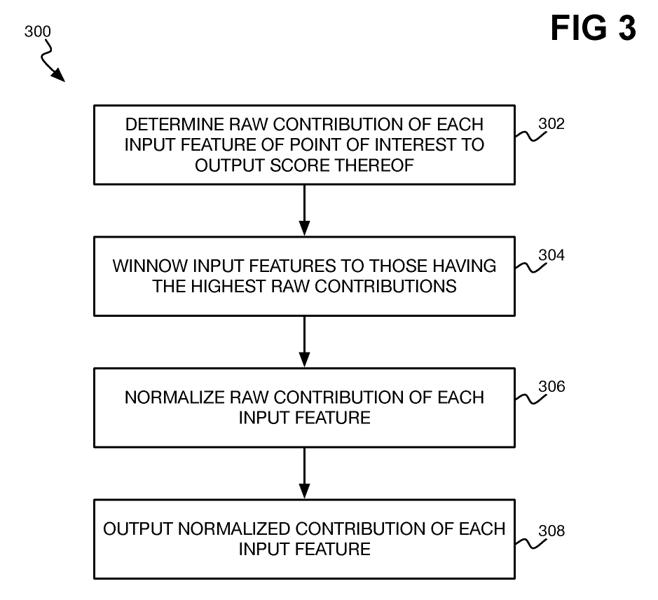

FIG. 3 shows an example method 300 as to how the feature contribution vector can be used to provide the input features in question in part 208. The raw contribution of the value of each input feature of the point of interest to the output score provided by the machine learning model for the point of interest is determined (302), using the feature contribution coefficient for the input feature in question. Specifically, the raw contribution of the value x^{a} for the feature a within the point of interest x is the product r^{a}=x^{a}·w^{a}.

Once the raw contribution of the value of each input feature of the point of interest to the output score has been determined, the input features can in one implementation be winnowed down to those having the highest raw contributions (304). This may be useful when there are a large number of input features, and the contributions thereof are in accordance with a “long tail” distribution—that is, a few input features have large raw contributions, and the majority of the input features have relatively small contributions. In this respect, the input features that have raw contributions below a threshold may be discarded in part 304, or input features other than a prespecified number of input features having the highest raw contributions may be discarded in part 304, as two examples.

The raw contribution of the value of each input feature of the point of interest to the output score generated by the machine learning model for the point of interest is normalized (306). If any input features were discarded in part 304, normalization occurs just in relation to the input features that were not discarded. The normalized contribution of the value for the feature a within the point of interest x is:

$${c}^{a} = \frac{\vert {r}^{a} \vert}{{\sum }_{j = 1}^{M} \vert {r}^{j} \vert} . \qquad ( 4 )$$

The summation in equation (4) is over the input features that remain after any winnowing has occurred in part 304. That is, if any input features were discarded in part 304, the resulting number of features M is correspondingly decreased. The normalized contribution of each input feature determined in part 306 can be output as to why the machine learning model provided the output score that it did for the point of interest (308).

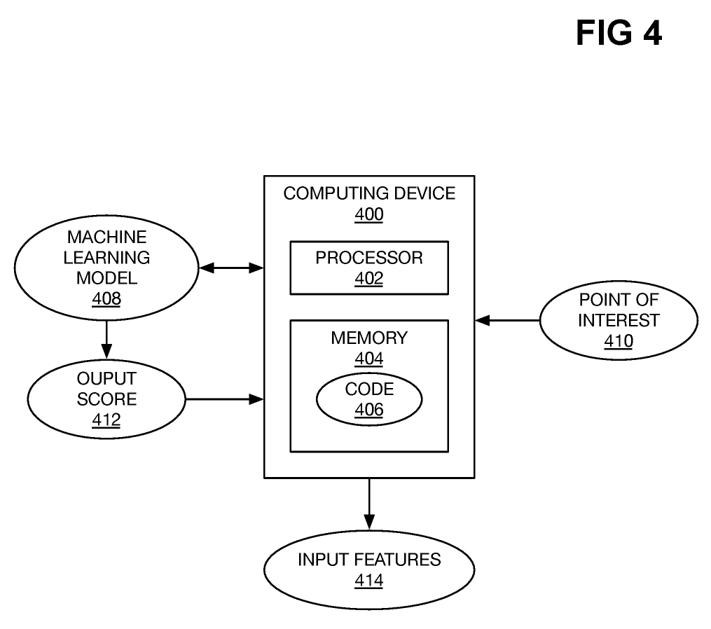

FIG. 4 shows an example computing device 400 that can perform the methods 200 and 300 of FIGS. 2 and 3 that have been described. The computing device 400 can be a desktop or a laptop computer, or another type of computing device. The computing device 400 includes at least a processor 402 and memory 404 storing code 406, which the processor 402 executes to perform the method 200 and/or the method 300.

In the example of FIG. 4, the machine learning model 408 is executed external to the computing device 400, but in another implementation, the computing device 400 can also implement the model 408. The computing device 400 thus receives a point of interest 410 for which the machine learning model 408 generates an output score 412. The computing device 400 then executes the code 406 to identify the input features 414 of the point of interest 410 that the machine learning model 408 primarily used to generate the output score 412 for the point of interest 410, as has been described.

The techniques that have been described therein thus provide a new and specific manner by which a computer's capabilities can be improved in relation to machine learning. Such a machine learning computer system in accordance with the techniques described herein can therefore perform functionality that it could not previously, resulting in improved user interaction with a machine learning system. The techniques described herein are particular and unconventional techniques with respect to identifying the input features that are most responsible for a machine learning system having provided a given output score for a point of interest.

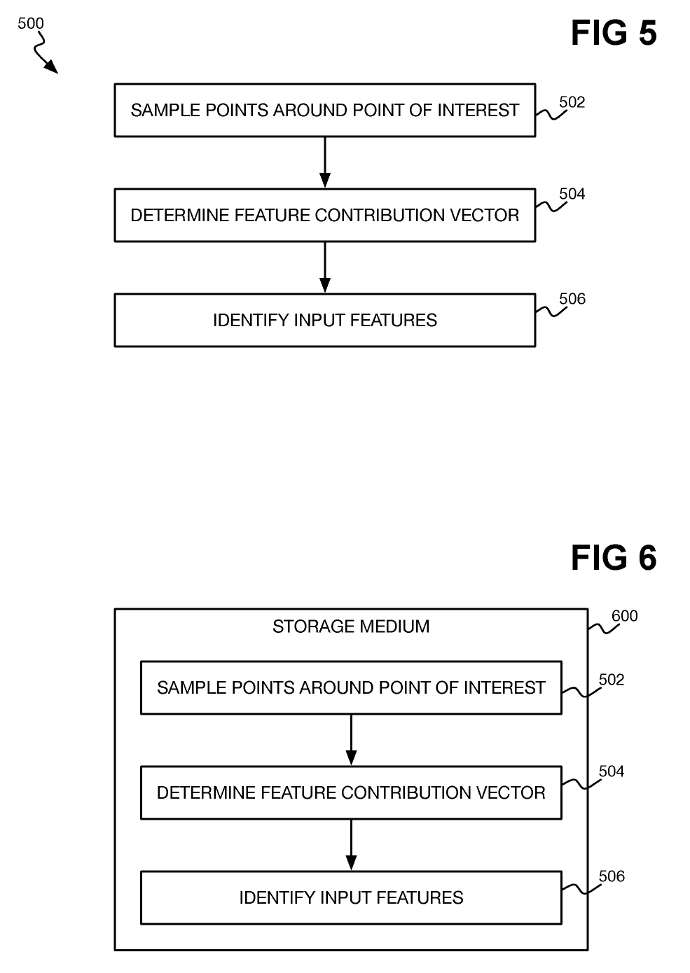

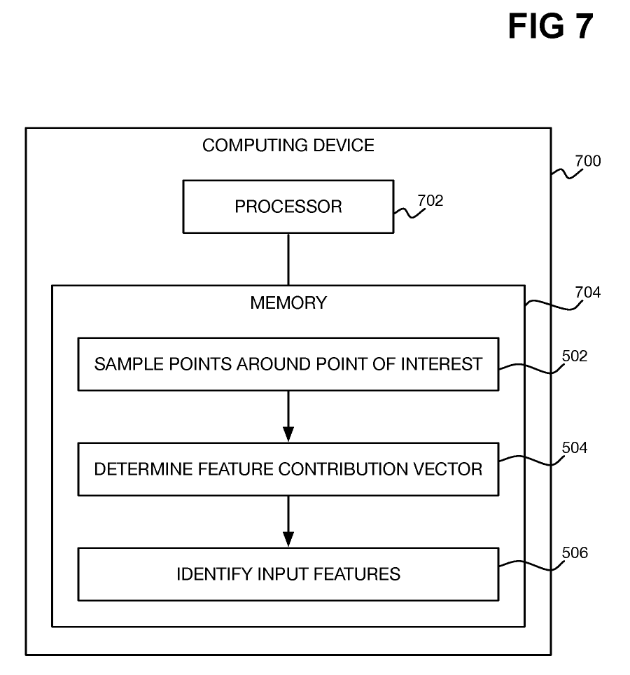

FIGS. 5, 6, and 7 show a method 500, a storage medium 600, and a computing device 700, respectively. The method 500 includes steps, parts, or acts 502, 504, and 506. The storage medium 600 can embody or store instructions or program code that when executed by a processor causes steps, parts, or acts 504, 504, and 506 to be performed. The computing device 700 can include a processor 702 and a memory 704, where the latter may also embody or store instructions or program code that when execute by the processor 702 causes steps, parts, or acts 502, 504, and 506 to be performed.

As has been described, therefore, points around a point of interest are sampled (502). The points and the point of interest each have a value for each of a number of input features. A feature contribution vector for the input features is determined (504), and the input features that a machine learning model primarily used in providing an output score for the point of interest are identified based on the feature contribution vector (506). That is, the input features that are most responsible for the machine learning model having provided the output score for the point of interest are identified.

We claim:

1. A method comprising:
sampling, by a computing device, a plurality of points around a point of interest, the points and the point of interest each having a value for each of a plurality of input features, the points and the point of interest each having a corresponding output score for a machine learning model;
determining, by the computing device, a feature contribution vector for the input features by locally approximating the machine learning model at the points and the point of interest using a ridge regression model, the feature contribution vector approximating for any point of the points and the point of interest a contribution of each input feature to the output score of the any point by the machine learning model; and
identifying, by the computing device, the input features that the machine learning model primarily used in providing the corresponding output score for the point of interest, based on the feature contribution vector.

2. The method of claim 1, wherein locally approximating the machine learning model using the ridge regression model comprises fitting the ridge regression model to the points, the point of interest, and the corresponding output scores of the points and the point of interest.

3. The method of claim 1, wherein the ridge regression model has a loss function.

4. The method of claim 3, wherein the loss function defines a difference between the ridge regression model and the machine learning model over the points and the point of interest.

5. The method of claim 3, wherein locally approximating the machine learning model using the ridge regression model comprises minimizing the loss function.

6. The method of claim 3, wherein the loss function comprises a term that biases the ridge regression model away from a uniform distribution approximation of the contributions of the input features to the output score of the any point by the machine learning model.

7. The method of claim 3, wherein the loss function comprises a term that biases the ridge regression model towards a minimization of a number of the input features that maximally contribute to the output score of the any point by the machine learning model, in approximating the contributions of the input features to the output score of the any point by the machine learning model.

8. The method of claim 3, wherein the loss function comprises a Kullback-Leibler (KL) divergence term.

9. The method of claim 1, wherein the feature contribution vector comprises a plurality of feature contribution coefficients corresponding to the input features, each feature contribution coefficient indicative of the contribution of the input feature to which the feature contribution coefficient corresponds.

10. The method of claim 9, wherein identifying the input features that the machine learning model primarily used in providing the corresponding output score for the point of interest comprises:
determining a raw contribution of the value of each input feature of the point of interest to the corresponding output score of the point of interest by the machine learning model, from the value of the input feature of the point of interest and from the feature contribution coefficient corresponding to the input feature;
normalizing the raw contribution of each input feature of the point of interest to the corresponding output score of the point of interest by the machine learning model;
outputting the raw contribution, as normalized, of each input feature of the point of interest to the corresponding output score of the point of interest by the machine learning model.

11. The method of claim 10, wherein identifying the input features that the machine learning model primary used in providing the corresponding output score for the point of interest comprises, after determining the raw contribution of the value of each input feature of the point of interest to the corresponding output score of the point of interest by the machine learning model, and before normalizing the raw contribution of each input feature of the point of interest to the corresponding output score of the point of interest by the machine learning model:
winnowing the input features to a number thereof for which the raw contributions are highest.

12. The method of claim 1, further comprising, prior to sampling the points around the point of interest:
transforming the input features to a plurality of simplified input features,
wherein the feature contribution vector is determined for the input features as transformed to the simplified input features.

13. A non-transitory computer-readable data storage medium storing program code executable by a processor to:
sample a plurality of points around a point of interest, the points and the point of interest each having a value for each of a plurality of input features, the points and the point of interest each having a corresponding output score for a machine learning model;
determine a feature contribution vector for the input features by locally approximating the machine learning model at the points and the point of interest via minimization of a loss function between the machine learning model and an approximating localized model, the feature contribution vector approximating for any point of the points and the point of interest a contribution of each input feature to the output score of the any point by the machine learning model; and
identify the input features that are most responsible for the machine learning model having provided the corresponding output score for the point of interest, based on the feature contribution vector,
wherein the loss function comprises a term that biases the approximating localized model towards a minimization of a number of the input features that maximally contribute to the output score of the any point by the machine learning model, in approximating the contributions of the input features to the output score of the any point by the machine learning model.

14. The non-transitory computer-readable data storage medium of claim 13, wherein the term biases the ridge regression model towards a minimization of a number of the input features that maximally contribute to the output score of the any point by the machine learning model, in approximating the contributions of the input features to the output score of the any point by the machine learning model.

15. The non-transitory computer-readable data storage medium of claim 13, wherein the loss function comprises a Kullback-Leibler (KL) divergence term.

16. The non-transitory computer-readable data storage medium of claim 13, wherein the approximating localized model comprises a linear regression model.

17. The non-transitory computer-readable data storage medium of claim 16, wherein the linear regression model is a lasso regression model.

18. The non-transitory computer-readable data storage medium of claim 16, wherein the linear regression model is a ridge regression model.

19. A computing device comprising:
a processor; and
a memory storing instructions that the processor is to execute to:
sample a plurality of points around a point of interest, the points and the point of interest each having a value for each of a plurality of input features, the points and the point of interest each having a corresponding output score for a machine learning model;
determine a feature contribution vector for the input features by locally approximating the machine learning model at the points and the point of interest using a ridge regression model having a loss function with a Kullback-Leibler (KL) divergence term, the feature contribution vector approximating for any point of the points and the point of interest a contribution of each input feature to the output score of the any point by the machine learning model; and
identify the input features most responsible for the machine learning model having provided the corresponding output score for the point of interest, based on the feature contribution vector.

20. The computing device of claim 19, wherein the loss function defines a difference between the ridge regression model and the machine learning model over the points and the point of interest,
and wherein the processor is to determine the feature contribution vector by locally approximating the machine learning model using the ridge regression model via minimizing the loss function.
